(19) United States
(12) Patent Application Publication
(10) Pub. No.: US 2026/0257538 A1
(43) Pub. Date: Sep. 3, 2026

(54) Motor Vehicle With an Air Vent Having a Fragrance-Dispensing Means

(71) Applicant: Bayerische Motoren Werke Aktiengesellschaft, Muenchen (DE)

(72) Inventors: Annabelle Coffinet, Muenchen (DE); Mark Jukes, Chichester (GB)

(21) Appl. No.: 19/373,859

(22) Filed: Oct. 30, 2025

(30) Foreign Application Priority Data
Feb. 28, 2025 (DE) 20 2025 101 077.1

(51) Int. Cl. B60H 3/00

(52) U.S. Cl. CPC B60H 3/0028; B60H 2003/0042

(57) ABSTRACT

A motor vehicle has a floor and an air vent located on the floor. The air vent has at least one air guide channel with an inflow side and an outflow side and is configured to conduct an air flow from the inflow side through the outflow side into an interior of the motor vehicle. A cover for the air vent partially covers the air guide channel to form a space. At least one fragrance-emitting element is positioned in the space, which is in fluidic communication with the air guide channel without the air flow directly flowing against or through the fragrance-emitting element.

### CROSS REFERENCE TO RELATED APPLICATION

This application claims priority under 35 U.S.C. § 119 from German Patent Application No. DE 20 2025 101 077.1, filed Feb. 28, 2025, the entire disclosure of which is herein expressly incorporated by reference.

### BACKGROUND AND SUMMARY

The present invention relates to a motor vehicle with an air vent having a fragrance-dispensing system.

Motor vehicles with a floor and an air vent located on the floor are known in practice, with each air vent having at least one air guide channel with an inflow side and an outflow side. The air vent is configured to direct an air flow from the inflow side through the outflow side into the vehicle interior. These motor vehicles have proven themselves in practice.

It is the object of the present invention to provide a generic motor vehicle with which the air flowing into the vehicle interior has an additional quality.

This object is achieved by a motor vehicle according to the independent claim(s). Advantageous developments are indicated in the dependent claims.

Specifically, this object is solved by a motor vehicle having a floor and an air vent located on the floor. The air vent has at least one air guide channel with an inflow side and an outflow side and is configured to conduct an air flow from the inflow side through the outflow side into the motor vehicle interior. The air vent has at least one cover which partially covers the air guide channel to form a space.

The motor vehicle according to the invention is characterized in that at least one fragrance-emitting element is positioned in the space, which is in fluidic communication with the air guide channel without the air flow directly flowing against or through the fragrance-emitting element.

According to the invention, the air flowing in the air guide channel, which on the inflow side can originate in particular from an air conditioning device and/or ventilation device, is guided past the fragrance-dispensing element, so that there is no direct contact between the air flow and the fragrance-dispensing element. Nevertheless, the fragrance-dispensing element is fluidically connected to the air guide channel, so that the air discharged into the vehicle interior on the flow outlet side is scented. The fragrance is advantageously discharged precisely and without the need for additional technical means, e.g. additional fans or the like, quasi-based on a principle that can be compared to the operating principle of jet pumps.

The fragrance-dispensing element can, in principle, be formed in any suitable manner. Particularly advantageously, the fragrance-dispensing element is formed as an air-permeable cushion containing a material containing a fragrance, preferably perfume.

The fragrance-emitting element can, in principle, be accommodated in the space in any suitable manner. According to a preferred embodiment, it is provided that the fragrance-emitting element is detachably attached to the cover. This advantageously allows for easy replacement of the fragrance-emitting element. This is all the more true if the cover itself is detachably attached to the air guide channel and/or the floor located in the vehicle interior. The detachable attachment of the fragrance-emitting element to the cover can advantageously be achieved, in particular, by double-sided adhesive tape or a Velcro fastener.

According to a further preferred embodiment, it is provided that a part of a carpet located on the floor of the motor vehicle interior is accommodated in the space. This advantageously allows for a more versatile use of the space.

According to an additional preferred embodiment, it is provided that the carpet and the fragrance-emitting element are spaced apart from each other and/or that the fragrance-emitting element has a physical and/or chemical barrier, in particular a plastic layer, which is configured to at least reduce or completely prevent the release of fragrance to the carpet. This makes it advantageously possible to avoid or completely prevent the unintentional release of fragrance onto the carpet.

A detailed, non-prejudicial, in particular non-limiting, description of an exemplary embodiment of the present invention is given below with reference to the figures. Identical elements are provided with identical reference signs unless otherwise stated.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view of a part of a motor vehicle equipped with an air vent.

FIG. 2 is a simplified sectional view along section A-A of the air vent represented in FIG. 1.

### DETAILED DESCRIPTION OF THE DRAWINGS

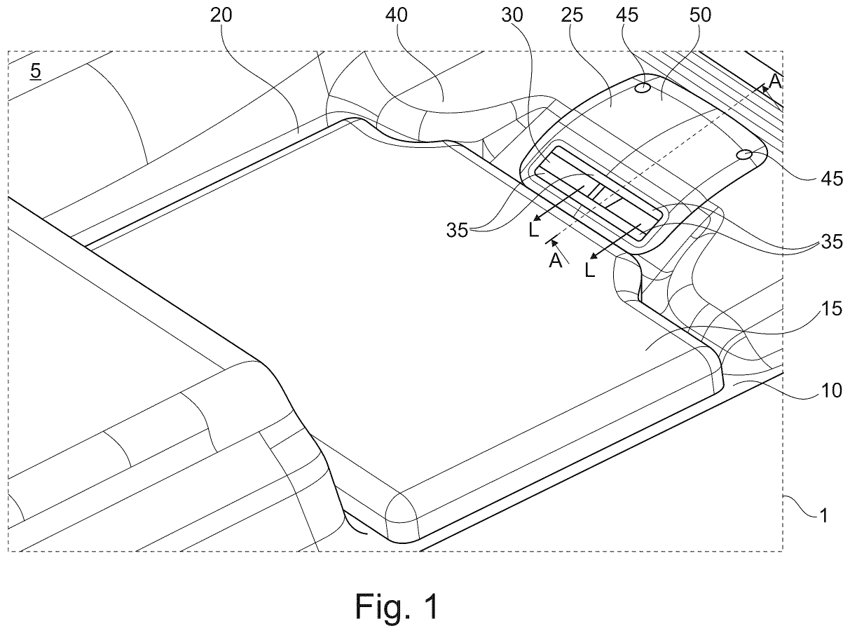

FIG. 1 shows a part of a symbolically represented motor vehicle 1 with its motor vehicle interior 5. In a footwell 10 within the motor vehicle interior 5, there is a recess 20 lined with a carpet 15. Above and adjacent to a virtual plane formed by the carpet 15, there is an air vent 25, the outflow side 30 of which has a number of slats 35. The air vent 25 is mounted on the floor 40 of the motor vehicle 1 and is operatively connected to an air conditioning system (not represented here). According to the embodiment shown here, the air vent 25 is fastened by means of two screws 45, with which a cover 50 of the air vent 25 is mounted on the floor 40 of the motor vehicle 1. Air originating from the air conditioning system can be discharged through the air vent 25 into the motor vehicle interior 5, as symbolized by the two arrows labeled L.

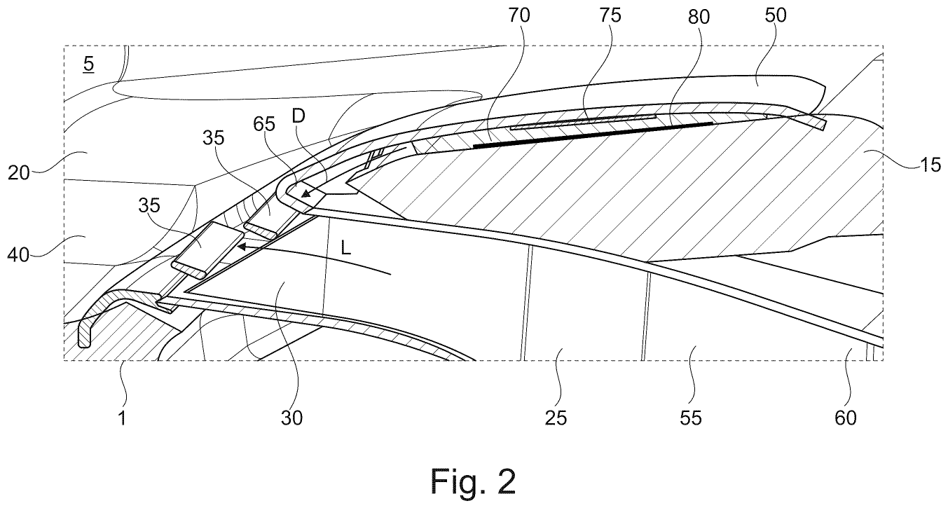

A sectional representation along the line of intersection A-A of FIG. 1 is shown in FIG. 2. The air vent 25 has an air guide channel 55 with the known outflow side 30 and an inflow side 60 operatively connected to the air conditioning system (not shown). The cover 50 covers the air guide channel 55, forming a space 65 such that part of the carpet 15 is accommodated in the space 65. Furthermore, a fragrance-dispensing element 70, which according to the exemplary embodiment shown here is designed as a pocket containing a fragrance, is located in the space 65. Specifically, the fragrance-dispensing element 70 rests with one side on the carpet 15 accommodated in the space 65 and with its opposite side against the cover 50. The latter side of the fragrance-dispensing element 70 is detachably attached to the cover 50 by means of a double-sided adhesive tape 75. It should be noted, however, that the fragrance-dispensing element 70 can also be formed such that it does not rest directly on the carpet 15, but is spaced apart from it. To avoid the transfer of fragrance from the fragrance-dispensing element 70 to the adjacent carpet 15, the fragrance-dispensing element 70 is provided with a barrier 80.

The fragrance-dispensing element 70 is positioned in the space 65 such that it is fluidically connected to the air guide channel 55, without the air flow L flowing in it directly flowing against or through the fragrance-dispensing element 70, as symbolized by the arrow D.

If the fragrance-dispensing element 70 needs to be replaced, it is only necessary to loosen the screws 45 and remove the cover 50 from the carpet 15. From the thus removed cover 50, only the fragrance-dispensing element 70 needs to be replaced with another fragrance-dispensing element 70, not shown here. The cover 50 is then reinstalled in the footwell 10.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Motor vehicle
5 Motor vehicle interior
10 Footwell
15 Carpet
20 Recess
25 Air vent
30 Outflow side
35 Slats
40 Floor
45 Screws
50 Cover
55 Air guide channel
60 Inflow side
65 Space
70 Fragrance-emitting element
75 Air input side
80 Barrier
D Fragrance-carrying air flow in space 65
L Air

What is claimed is:

1. A motor vehicle, comprising:
a floor;
an air vent located on the floor, the air vent having at least one air guide channel with an inflow side and an outflow side and being configured to conduct an air flow from the inflow side through the outflow side into an interior of the motor vehicle;
a cover for the air vent, the cover partially covering the air guide channel to form a space; and
at least one fragrance-emitting element positioned in the space, the at least one fragrance-emitting element being in fluidic communication with the air guide channel without the air flow directly flowing against or through the fragrance-emitting element.

2. The motor vehicle according to claim 1, wherein the fragrance-emitting element is detachably fastened to the cover.

3. The motor vehicle according to claim 1, wherein
a part of a carpet located on the floor of the motor vehicle interior is accommodated in the space.

4. The motor vehicle according to claim 3, wherein
the carpet and the fragrance-emitting element are spaced apart from each other, and/or
the fragrance-emitting element has a physical and/or chemical barrier which is configured to at least reduce a release of fragrance to the carpet.
